(19) United States
(12) Patent Application Publication
(10) Pub. No.: US 2006/0196949 A1
(43) Pub. Date: Sep. 7, 2006

(54) Wide band IC tag

(76) Inventors: Koji Ando, Kyoto-shi (JP); Keisuke Saito, Kyoto-shi (JP); Kosuke Hayama, Kyoto-shi (JP)

Correspondence Address: DICKSTEIN SHAPIRO MORIN & OSHINSKY LLP, 2101 L Street, NW, Washington, DC, 20037, US

(21) Appl. No.: 11/355,151

(22) Filed: Feb. 16, 2006

(30) Foreign Application Priority Data
Feb. 23, 2005 (JP) 2005-47264

(51) Int. Cl. G06K 19/06

(52) U.S. Cl. 235/492

(57) ABSTRACT

This invention provides a wide band IC tag in which the vicinity of an IC portion arranged in a tag main body can be arranged in a portion difficult to be influenced by an object. Therefore, this invention is characterized in the wide band IC tag for connecting the IC portion arranged in the tag main body and an antenna portion, wherein the IC portion is arranged at an end of the tag main body.

### BACKGROUND OF THE INVENTION

1. Field of the Invention

This invention relates to a wide band IC tag used for physical distribution management of a packing box for storing an object having a dielectric constant of e.g., a metal, water, etc. in a RFID tag operated by a radio wave from a UHF band to an SHF band.

2. Background Art

As the above IC tag, as shown in FIG. 15, there is a RFID tag 20 of a first related-art example (see patent literature 1) stuck to a container outer wall face not coming in contact with liquid within the container. When this RFID tag 20 is stuck to a packing box A storing a container B of a bottle type shown in FIG. 3, an IC portion 21 is arranged in the central portion of the RFID tag 20. Therefore, it is impossible to arrange this IC portion 21 in a corner portion of the packing box A difficult to be influenced by drinking water C filled in the container B. Further, antenna elements 22, 22 as conductors are formed on the entire tag face. Therefore, when the drinking water C having the dielectric constant exists near the IC portion 21, the IC portion 21 is greatly influenced by this drinking water C. A resonance frequency is greatly moved by the influence of the drinking water C so that no IC tag functions as the RFID tag 20.

Further, in a RFID tag 10 of a second related-art example as shown in FIG. 16, an IC portion 12 of a dipole antenna 11 can be arranged in the corner portion of the packing box difficult to be influenced by an object. However, the number of resonance frequencies of antenna elements 13, 13 connected to the IC portion 12 of the dipole antenna 11 is one, and a frequency band functioning as the antenna is generally narrow. Therefore, even when the resonance frequency is moved only slightly, it does not function as the antenna.

On the other hand, the IC tag functioning in the UHF band is strongly influenced by the object having the dielectric constant. In particular, it is experientially known to have the characteristics that an IC circumferential portion is strongly influenced by this object.

Patent literature 1: JP-A-2002-259934

### SUMMARY OF THE INVENTION

In consideration of the above problems, an object of this invention is to provide a wide band IC tag in which the vicinity of the IC portion arranged in a tag main body can be arranged in a portion difficult to be influenced by the object substance.

A wide band IC tag of the invention described in a first aspect of the invention connects an IC portion arranged in a tag main body and an antenna portion, and functions in a frequency band from a UHF band to an SHF band; wherein the IC portion is arranged at an end of the tag main body.

In accordance with this invention, for example, when the wide band IC tag is attached to a packing box storing an object having the dielectric constant of a metal, water, etc., it is supposed that various objects having the dielectric constants are stored into the packing box. However, it is seldom that the interior of the packing box is perfectly buried by certain objects until all the corners of the interior of the packing box. Further, the outer face of an angular portion of a container has a smooth curved surface shape. Therefore, when the container is stored in the packing box, a clearance exists in a corner portion of the interior of the packing box opposed to the angular portion outer face of the container. Therefore, the influence of the object with respect to the antenna portion near the IC portion can be set to be smaller than the influence of the object affecting the antenna portion separated distantly from the IC portion. Thus, a reduction in the function of the wide band IC tag can be restrained as much as possible.

Namely, if the vicinity of the IC portion arranged at an end of the tag main body is arranged in a portion difficult to be influenced by the object in the corner portion, etc. of the packing box having the above clearance, the influence of the object with respect to the antenna portion around the IC portion is small and a communication function of high reliability as the wide band IC tag is stably obtained. If the clearance uninfluenced by the object exists or can be secured, the wide band IC tag of the present invention can be also used in physical distribution management except for the packing box.

The wide band IC tag of the invention described in a second aspect of the invention is characterized in that the end of the tag main body is constructed by an edge portion or an angular corner portion of the tag main body in addition to the construction described in the above first aspect of the invention.

In accordance with this invention, for example, in accordance with the position of a portion difficult to be influenced by the object in the corner portion, etc. of the packing box having the clearance, an IC tag suitable to arrange the vicinity of the IC portion with respect to this portion is used by making a selection from the wide band IC tag having the IC portion arranged in an edge portion of the tag main body, and the wide band IC tag having the IC portion arranged in an angular corner portion of the tag main body.

The wide band IC tag of the invention described in a third aspect of the invention is characterized in that the antenna portion is constructed by an antenna element of a loop shape in addition to the construction described in the above first or the second aspect of the invention.

In accordance with this invention, a communication function having a wide frequency band and high reliability as the wide band IC tag is stably obtained in the antenna element of the loop shape.

The wide band IC tag of the invention described in a fourth aspect of the invention is characterized in that the antenna portion is constructed by plural antenna elements of different element lengths in addition to the construction described in any one of the above first to the third aspects of the invention.

In accordance with this invention, resonance frequencies are different in accordance with the element lengths of the antenna elements. Therefore, if the antenna portion is constructed by the plural antenna elements of different element lengths, the plural resonance frequencies are provided. Accordingly, even when a movement is made to the band exterior not functioning with respect to the resonance frequency of one antenna element by the influence of the object having the dielectric constant, the resonance frequency of another antenna element exists within a band functioning at a predetermined frequency. Therefore, a communication function functioning in a wide frequency band and having high reliability as the wide band IC tag is stably obtained.

The wide band IC tag of the invention described in a fifth aspect of the invention is characterized in that each antenna element is arranged in a comb shape or a fan shape in addition to the construction described in the above fourth aspect of the invention. This invention has an inside removing structure in which a space or a clearance exists between the respective antenna elements. Therefore, many resonance frequencies are provided, and the functioning frequency band is wide, and it is difficult to be influenced by the object.

The wide band IC tag of the invention described in a sixth aspect of the invention is characterized in that an arbitrary portion of the antenna element is bent in addition to the construction described in any one of the above third to the fifth aspects of the invention.

In accordance with this invention, for example, an arbitrary portion of the antenna element is bent by bending this arbitrary portion at an acute angle, or curving this arbitrary portion in a curve, etc. Thus, while a predetermined resonance frequency is maintained, the entire tag can be made compact.

The wide band IC tag of the invention described in a seventh aspect of the invention is characterized in that the number of antenna elements is set to an arbitrary number in addition to the construction described in any one of the above third to the sixth aspects of the invention. In accordance with this invention, the plural resonance frequencies are different in accordance with the element lengths of the respective antenna elements. Accordingly, the width of the frequency band functioning as the wide band IC tag can be arbitrarily set, and the frequency band is widened in comparison with a dipole antenna.

The wide band IC tag of the invention described in an eighth aspect of the invention is characterized in that the entire length or one portion of the antenna element is formed in a curve structure in addition to the construction described in any one of the above third to the seventh aspects of the invention. In accordance with this invention, if the entire length or one portion of the antenna element is formed in a shape meandered in a wavy shape, the entire tag can be made compact while a predetermined resonance frequency is maintained.

In accordance with this invention, when the wide band IC tag is attached to the packing box storing the object, the vicinity of the IC portion arranged at an end of the tag main body is arranged in a portion difficult to be influenced by the object of a clearance, etc. formed between the object having the dielectric constant of e.g., a metal, water, etc. and the packing box storing this object. Accordingly, the influence of the object with respect to the antenna portion around the IC portion can be reduced, and a communication function of high reliability as the wide band IC tag is stably obtained. Further, gain is high and communication distance is extended in comparison with the dipole antenna.

### BRIEF DESCRIPTION OF THE DRAWINGS

FIG. 1 is a plan view showing an IC tag in which an IC portion is arranged in the vicinity of one side edge portion.

FIG. 2 is a perspective view showing a state in which the IC tag is stuck to a packing box.

FIG. 3 is an enlarged sectional view showing a state in which the vicinity of the IC portion is arranged in a corner portion of the packing box.

FIG. 4 is a plan view showing another example in which an antenna element of FIG. 1 is bent.

FIG. 5 is a plan view showing another example in which plural antenna elements of FIG. 1 are arranged.

FIG. 6 is a plan view showing the IC tag in which the IC portion is arranged near an angular corner portion.

FIG. 7 is a plan view showing another example in which plural antenna elements of FIG. 6 are arranged.

FIG. 8 is a plan view showing the IC tag of an approximately circular shape seen from the front face.

FIG. 9 is a plan view showing another example in which plural antenna elements of FIG. 8 are arranged.

FIG. 10 is a plan view showing the IC tag having an antenna element of a comb shape.

FIG. 11 is a plan view showing the IC tag having an antenna element of a fan shape.

FIG. 12 is a plan view showing the IC tag in which an antenna element of a comb shape is slantingly arranged.

FIG. 13 is a plan view showing the IC tag in which two antenna elements are independently arranged.

FIG. 14 is a plan view showing the IC tag in which an antenna element is formed in a wavy shape.

FIG. 15 is a plan view showing the IC tag in which an antenna element of a first related-art example is arranged on the entire face.

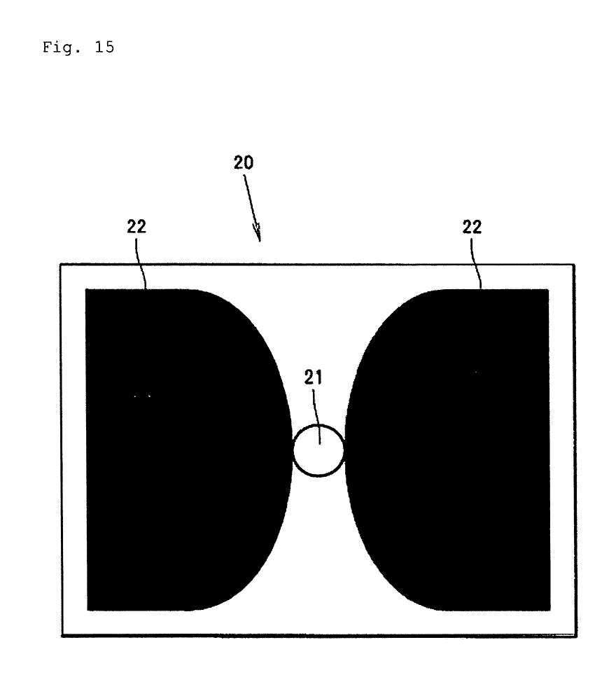

FIG. 16 is a plan view showing the IC tag using a dipole antenna of a second related-art example.

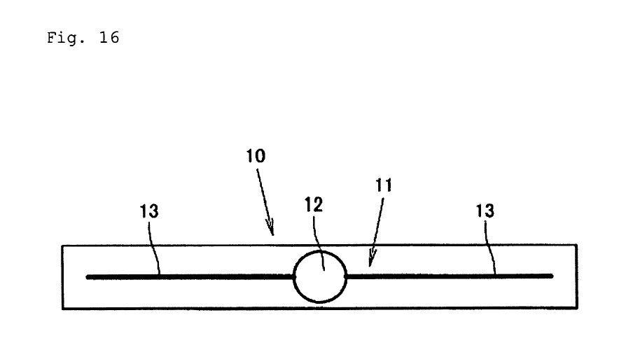

### DESCRIPTION OF THE PREFERRED EMBODIMENTS

In this invention, the purpose of being able to arrange the vicinity of the IC portion constituting the wide band IC tag in a portion difficult to be influenced by the object is attained by arranging this IC portion at the end of the tag main body.

One embodiment of this invention will next be described in detail on the basis of the drawings.

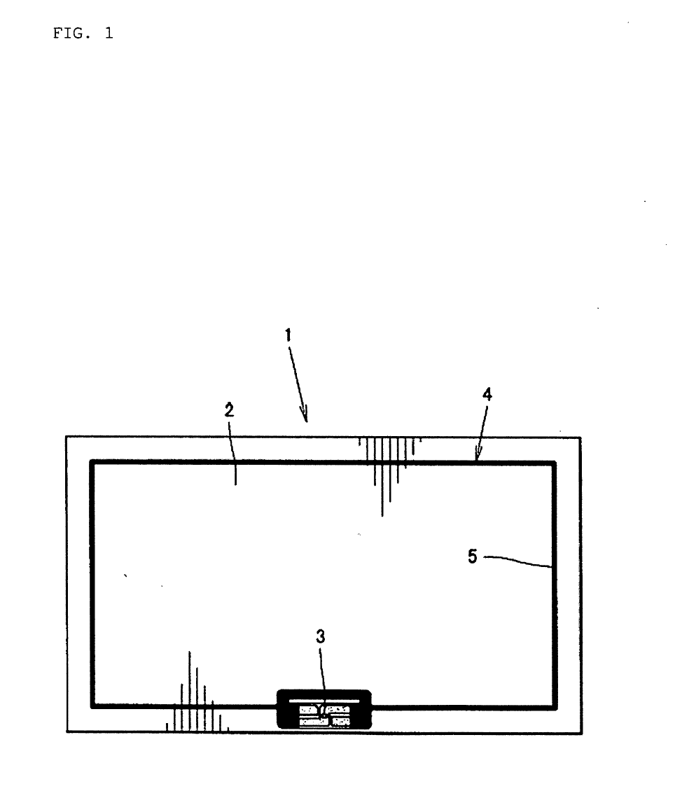

FIG. 1 shows a wide band IC tag 1 of a first embodiment mode in which an IC portion 3 arranged in a tag main body 2 in accordance with this invention and an antenna portion 4 of a loop shape are connected. This wide band IC tag 1 is a RFID tag functioning in a frequency band from a UHF band (850 MHz to 960 MHz) to an SHF band (2.4 GHz to 5 GHz). The IC portion 3 of a chip type arranged near a lower side edge portion of the tag main body 2 approximately formed in a rectangular shape seen from a plane, and an antenna element 5 of the antenna portion 4 arranged in a loop shape along upper and lower edge portions and left and right edge portions of the tag main body 2 are electrically connected.

A terminal portion of the single antenna element 5 arranged on the surface side along the upper and lower edge portions and the left and right edge portions of the tag main body 2 is connected to the IC portion 3 arranged in the central portion of the surface of the vicinity of the lower side edge portion of the above tag main body 2. Opposed end portions of this antenna element 5 are connected to each other, and are arranged so as to match the impedances of the IC portion 3 and the antenna portion 4.

The IC portion 3 may be also arranged near the upper side edge portion or the left-hand side edge portion and the right-hand side edge portion of the tag main body 2 approximately formed in the rectangular shape. Further, the IC portion 3 may be also arranged near one side edge portion of the tag main body 2 approximately formed in a square shape seen from the front face.

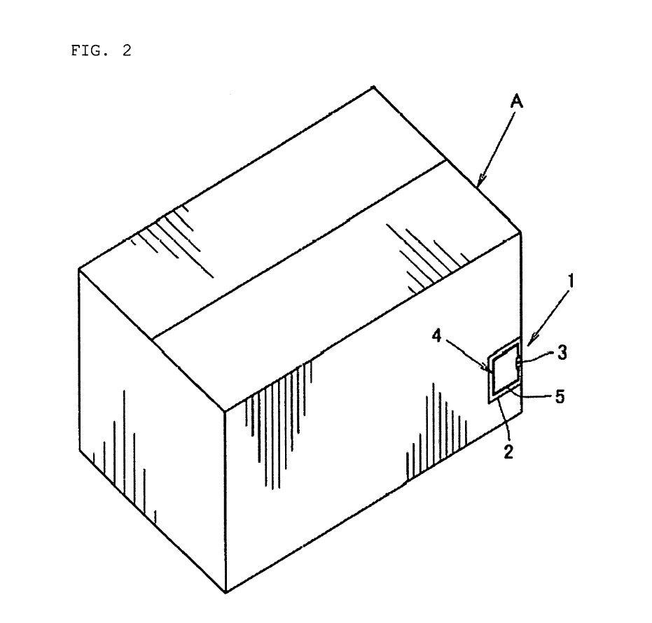

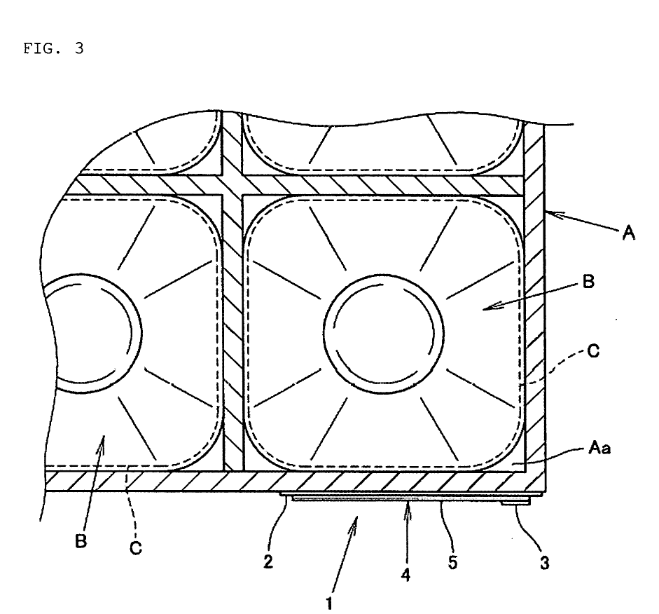

In accordance with this invention, for example, when the above wide band IC tag 1 is stuck to a packing box A storing an object having a dielectric constant of a metal, water, etc., it is seldom that the packing box A is perfectly buried by a container B of a bottle type filled with drinking water C as one example of water until all the corners of the interior of the packing box A as shown in FIGS. 2 and 3. Further, the outer face of an angular portion of the container B has a smooth curved surface shape. Therefore, a clearance Aa exists in the corner portion within the packing box A opposed to the angular portion outer face of the container B. Thus, the influence of the drinking water C with respect to the antenna portion 4 and the antenna element 5 around the IC portion 3 is set to be smaller than the influence of the drinking water C affecting the antenna portion 4 and a portion of the antenna element 5 separated distantly from the IC portion 3. Accordingly, a reduction in the function of the wide band IC tag can be restrained as much as possible.

Namely, when the wide band IC tag 1 is stuck to the corner portion of the packing box A, the influence of the drinking water C as an object with respect to the antenna portion 4 and the antenna element 5 around the IC portion 3 can be reduced if the vicinity of the IC portion 3 arranged near one side edge portion (lower side edge portion shown in FIG. 1) of the tag main body 2 is stuck in a state arranged in the corner portion of the packing box A in which the above clearance Aa exists. Accordingly, a communication function of high reliability is stably obtained as the wide band IC tag 1. Further, gain is high and communication distance is extended in comparison with a dipole antenna.

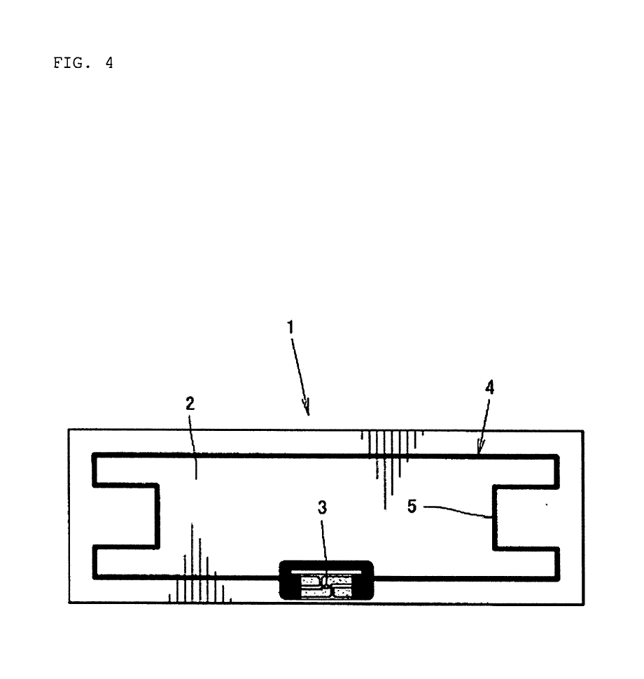

FIG. 4 shows another example of the wide band IC tag 1 in which one portion of the antenna element 5 constituting the antenna portion 4 of a loop shape is bent. For example, an element portion of a portion having a small electric current distribution of the antenna element 5 arranged along left and right edge portions of the tag main body 2 is bent by bending this element portion at an acute angle or curving this element portion in a curve, etc. except for the element portion of a portion having a large electric current distribution in the antenna element 5 arranged along upper and lower edge portions of the tag main body 2.

In accordance with this invention, the distance between the element portions of the antenna element 5 arranged along the upper and lower edge portions of the tag main body 2 is narrowed, and the entire tag can be made compact. Further, since the portion of the small electric current distribution of the antenna element 5 is bent, no flow of the electric current is obstructed and the loss of antenna gain can be reduced.

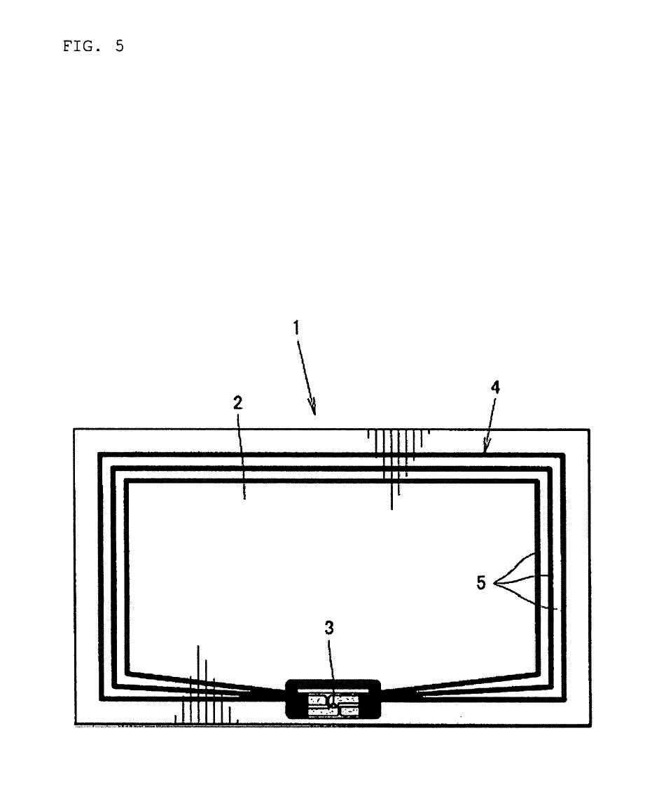

FIG. 5 shows another example of the wide band IC tag 1 in which the antenna portion 4 of a loop shape is constructed by each of plural antenna elements 5—of different element lengths. The IC portion 3 arranged near one side edge portion of the tag main body 2, and each antenna element 5—of the antenna portion 4 arranged along a circumferential edge portion of the tag main body 2 are electrically connected.

In accordance with this invention, the vicinity of the IC portion 3 arranged near one side edge portion of the tag main body 2 constituting the wide band IC tag 1 can be arranged in the corner portion of the packing box A in which the clearance Aa exists. Accordingly, an operation and an effect approximately equal to those of the first embodiment mode can be obtained. Further, the resonance frequency is different in accordance with the element length of each antenna element 5—. Therefore, if the antenna portion 4 is constructed by each of the plural antenna elements 5—of different element lengths, plural resonance frequencies are provided. Thus, a communication function functioning as a wide frequency band and having high reliability as the wide band IC tag 1 is stably obtained. Further, one portion of each antenna element 5—may be also bent.

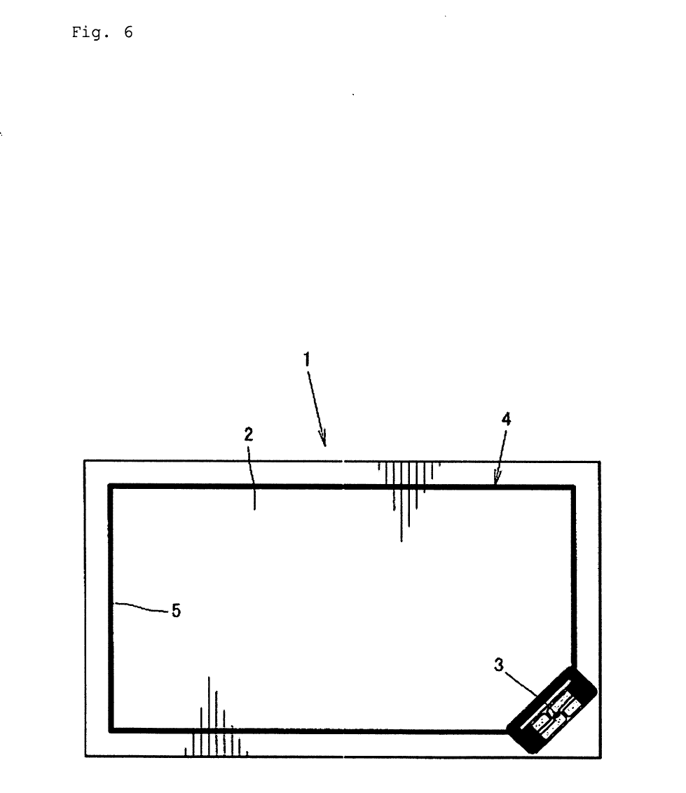

FIG. 6 shows a wide band IC tag 1 of a second embodiment mode in which the IC portion 3 is arranged near an angular corner portion of the tag main body 2. The IC portion 3 arranged near the angular corner portion of the tag main body 2, and the antenna element 5 of the antenna portion 4 arranged in a loop shape along a circumferential edge portion of the tag main body 2 are electrically connected.

In accordance with this invention, the vicinity of the IC portion 3 arranged in the angular corner portion of the tag main body 2 constituting the wide band IC tag 1 can be arranged in the corner portion of the packing box A in which the clearance Aa exists. Accordingly, an operation and an effect approximately equal to those of the first embodiment mode can be obtained.

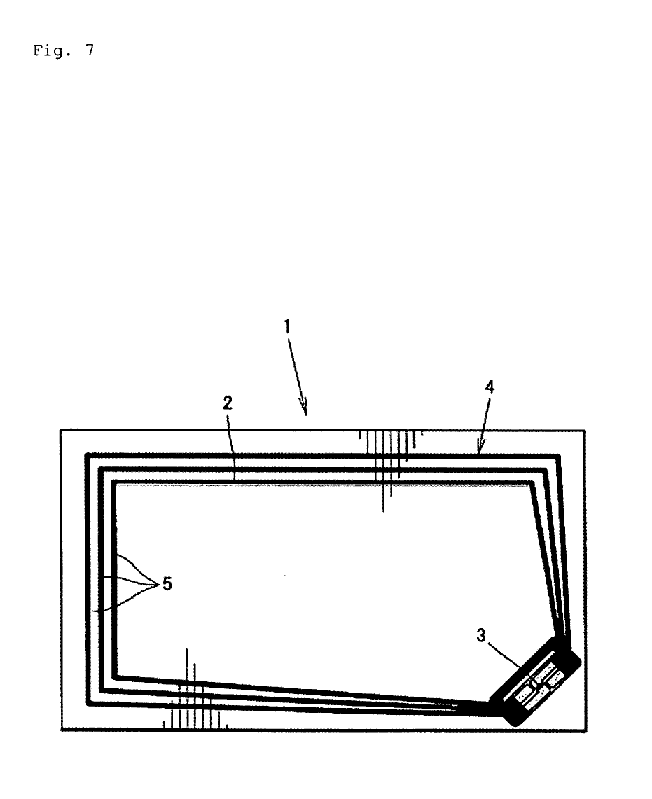

Further, as shown in FIG. 7, the antenna portion 4 of a loop shape may be also constructed by each of plural antenna elements 5—of different element lengths. Plural resonance frequencies are provided correspondingly to the element lengths of the respective antenna elements 5—. Therefore, an operation and an effect approximately equal to those of the wide band IC tag 1 of FIG. 5 can be obtained.

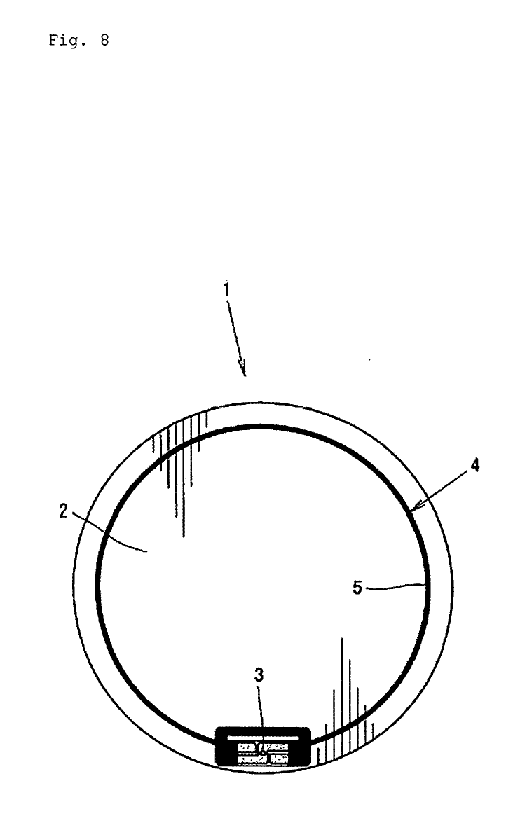

FIG. 8 shows a wide band IC tag 1 of a third embodiment mode in which the IC portion 3 is arranged near one side circumferential edge portion of the tag main body 2 approximately formed in a circular shape seen from the front face. The IC portion 3 arranged near one side circumferential edge portion of the tag main body 2, and the antenna element 5 of the antenna portion 4 arranged in a loop shape along the circumferential edge portion of the tag main body 2 are electrically connected.

In accordance with this invention, the vicinity of the IC portion 3 arranged in one side circumferential edge portion of the tag main body 2 constituting the wide band IC tag 1 can be arranged in the corner portion of the packing box A in which the clearance Aa exists. Accordingly, an operation and an effect approximately equal to those of the first embodiment mode can be obtained. Further, no directional property of the wide band IC tag 1 itself is restricted by an external appearance shape, and the vicinity of the IC portion 3 can be arranged toward a predetermined desirable direction.

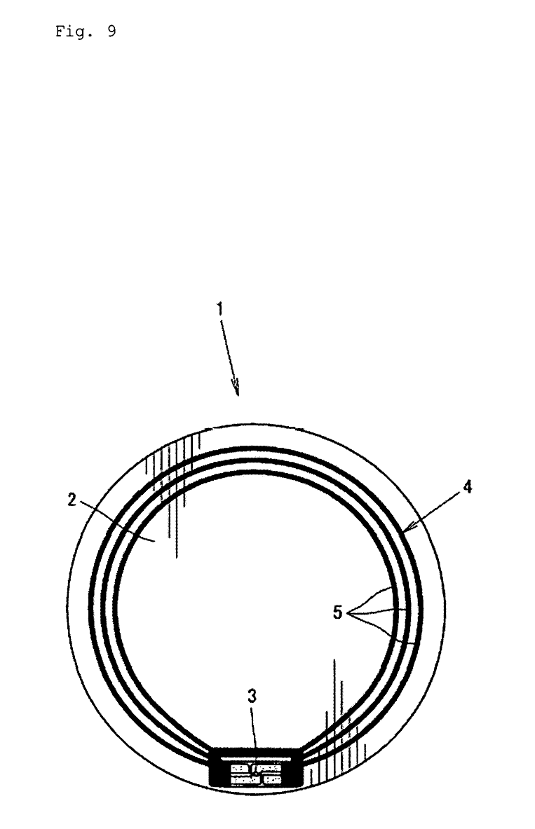

Further, as shown in FIG. 9, the antenna portion 4 of a loop shape may be also constructed by each of the plural antenna elements 5—of different element lengths. Plural resonance frequencies are provided correspondingly to the element lengths of the respective antenna elements 5—. Therefore, an operation and an effect approximately equal to those of the wide band IC tag 1 of FIG. 5 can be obtained.

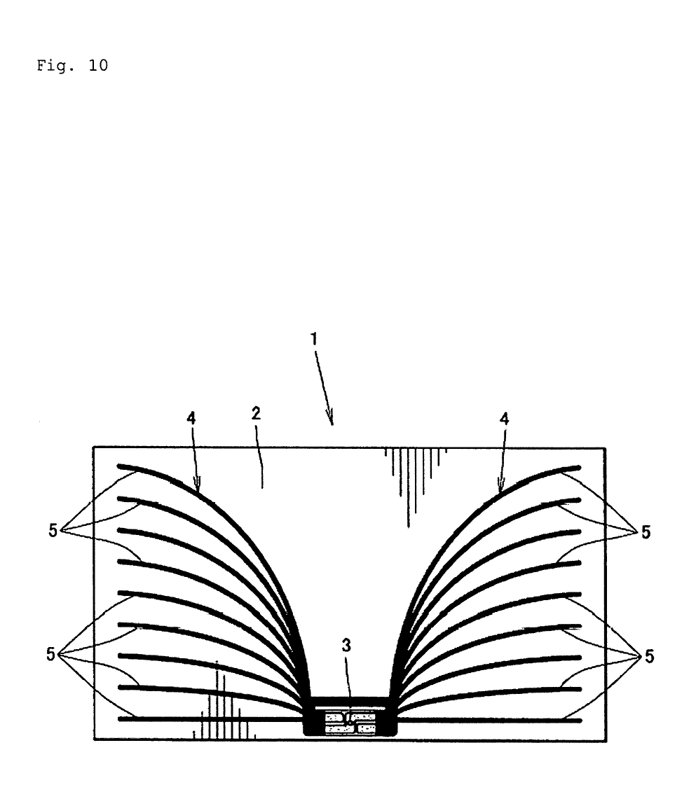

FIG. 10 shows a wide band IC tag 1 of a fourth embodiment mode constructed by the IC portion 3 arranged near one side edge portion (a lower side edge portion shown in this figure) of the tag main body 2, and a pair of left and right antenna portions 4, 4 arranged in both side portions of the IC portion 3. The pair of left and right antenna portions 4, 4 connected to the IC portion 3 are respectively constructed by each of plural antenna elements 5—of different element lengths formed in an arc shape, and are arranged in an order lengthened from the antenna element 5 of a lowermost column of a short element length to the antenna element 5 of an uppermost column of a long element length, or an increasing order of curvature radius.

Further, the respective antenna elements 5—are spaced so as not to come in contact with each other, and are arranged in a comb shape, and are arranged in a radial shape so as to gradually widen the clearance between the antenna elements 5 toward a direction for increasing the distance from the IC portion 3. Further, one end of each antenna element 5—is connected to the IC portion 3, but the other ends of the antenna elements 5 may be also connected to each other.

In accordance with this invention, the vicinity of the IC portion 3 arranged near one side edge portion of the tag main body 2 constituting the wide band IC tag 1 can be arranged in the corner portion of the packing box A in which the clearance Aa exists. Accordingly, an operation and an effect approximately equal to those of the first embodiment mode can be obtained. Further, plural resonance frequencies are provided correspondingly to the element lengths of the respective antenna elements 5—. Therefore, a communication function having a wide frequency band functioning as the wide band IC tag 1, and having high reliability is stably obtained.

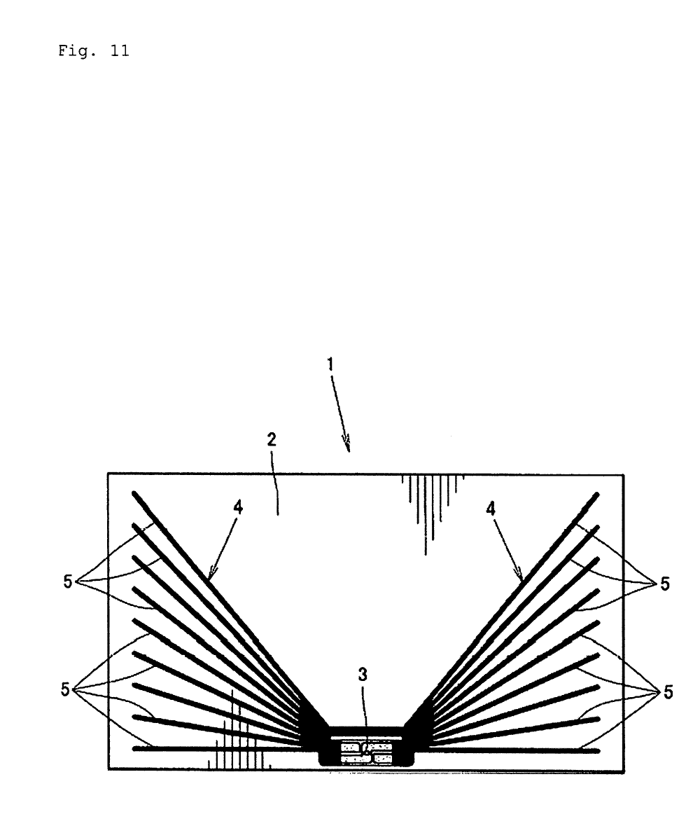

Further, instead of each antenna element 5—of a curve structure, as shown in FIG. 11, the respective antenna elements 5—of a straight line structure of different element lengths may be arranged in a fan shape spaced at a predetermined equal angle. Thus, an operation and an effect approximately equal to those of the wide band IC tag 1 of FIG. 10 can be obtained.

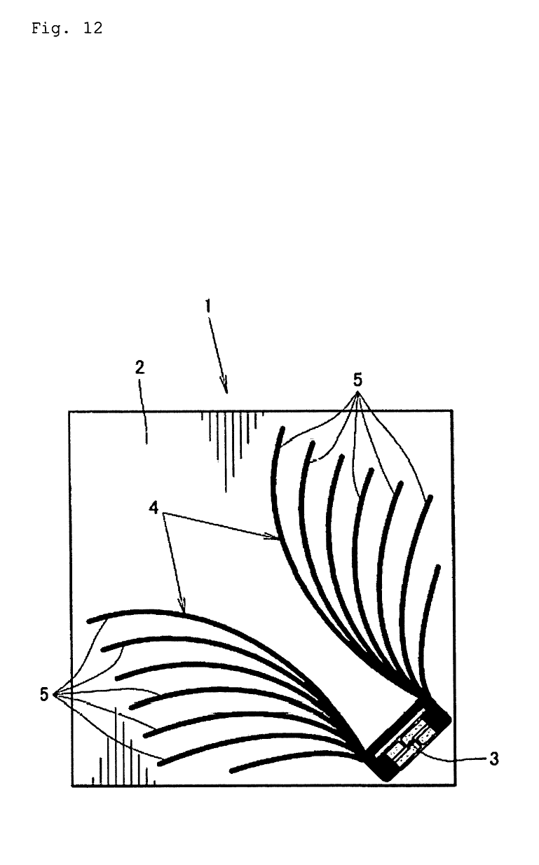

FIG. 12 shows a wide band IC tag 1 of a fifth embodiment mode constructed by the IC portion 3 arranged near an angular corner portion of the tag main body 2, and a pair of upper and lower antenna portions 4, 4 arranged in a slanting upper portion and a slanting lower portion of the IC portion 3. The pair of upper and lower antenna portions 4, 4 connected to the IC portion 3 are respectively constructed by each of plural antenna elements 5—of different element lengths arranged in a comb shape, and are arranged in an order lengthened from the antenna element 5 of a short element length arranged in a rightward lower angular corner portion of FIG. 12 to the antenna element 5 of a long element length arranged in a leftward upper angular corner portion, or an increasing order of curvature radius.

In accordance with this invention, the vicinity of the IC portion 3 arranged near the angular corner portion of the tag main body 2 constituting the wide band IC tag 1 can be arranged in the corner portion of the packing box A in which the clearance Aa exists. Accordingly, an operation and an effect approximately equal to those of the first embodiment mode can be obtained. Further, plural resonance frequencies are provided correspondingly to the element lengths of the respective antenna elements 5—. Therefore, a communication function having a wide frequency band functioning as the wide band IC tag 1 and having high reliability is stably obtained. Further, each antenna element 5—of the curve structure can be also changed to each antenna element 5—of a straight line structure as shown in FIG. 9.

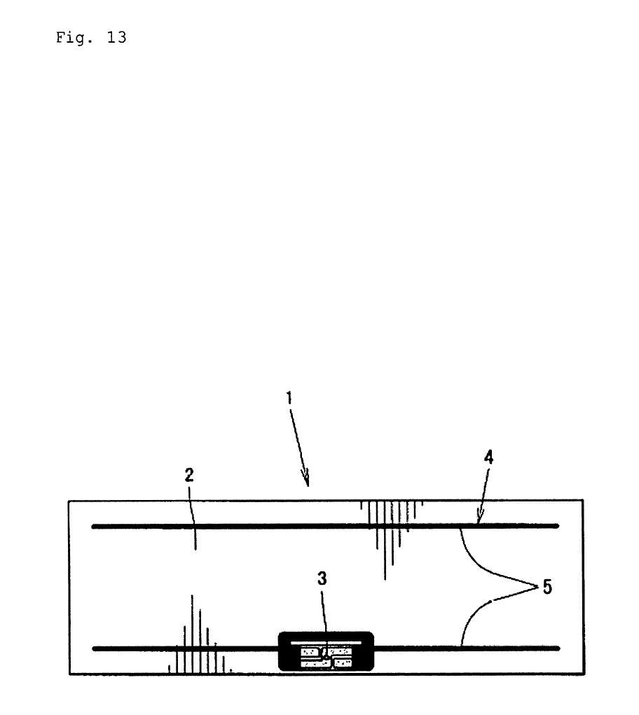

FIG. 13 shows a wide band IC tag 1 of a sixth embodiment mode in which two antenna elements 5, 5 having element lengths approximately equal to each other are spaced by a predetermined distance and are arranged in parallel with each other. The IC portion 3 arranged near a lower side edge portion of the tag main body 2 is connected to an intermediate portion of the antenna element 5 arranged along this lower side edge portion. The antenna element 5 arranged along an upper side edge portion of the tag main body 2 is freely arranged, and the antenna portion 4 is constructed by two antenna elements 5, 5 formed by upper and lower antennas.

In accordance with this invention, the upper and lower antenna elements 5, 5 constituting the antenna portion 4 are resonated at predetermined frequencies. Therefore, a communication function of high reliability is stably obtained as the wide band IC tag 1, and an operation and an effect approximately equal to those of the second embodiment mode can be obtained. Further, the respective plural antenna elements 5,—having element lengths approximately equal to each other may be spaced at a predetermined interval and arranged in parallel with each other with the antenna element 5 connected to the IC portion 3 as a reference.

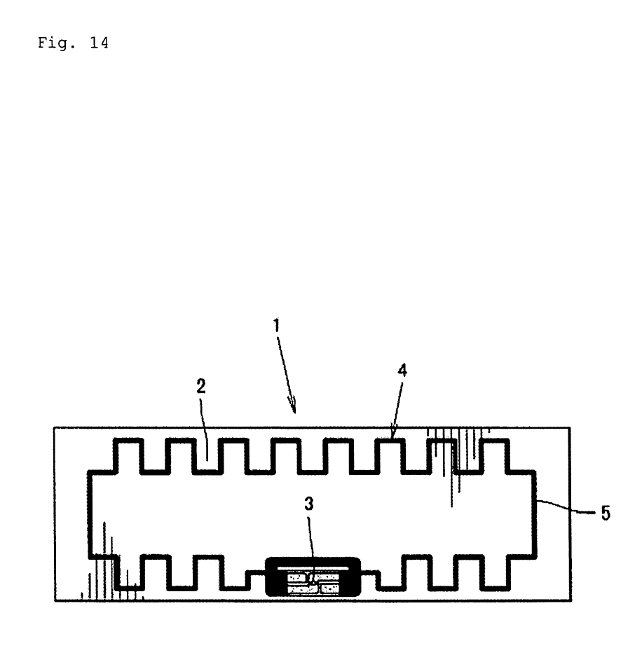

FIG. 14 shows a wide band IC tag 1 of a seventh embodiment mode in which the entire length of the antenna element 5 of the antenna portion 4 arranged in a loop shape is formed in a shape meandered in a wavy shape. The IC portion 3 is arranged near a lower side edge portion of the tag main body 2. Accordingly, an operation and an effect approximately equal to those of the above first embodiment mode can be obtained. Further, the entire length of the antenna element 5 constituting the antenna portion 4 is formed in the wavy shape toward the length direction. Accordingly, similar to the wide band IC tag 1 of FIG. 4, the entire tag can be made compact while maintaining a predetermined resonance frequency. Further, one portion of the antenna element 5 may be also formed in the wavy shape.

The entire length or one portion of the antenna element 5 shown in each of FIGS. 4 to 13 may be also formed in a shape meandered in the wavy shape.

This invention is not limited to only the constructions of the above embodiments, but can be applied on the basis of technical ideas shown in the claims, and many embodiment modes can be obtained.

In the embodiments, each of the plural antenna elements 5 is set to the same element width, but may be also set to a different element width. Further, the antenna elements 5 arranged in a loop shape or a comb shape, and a fan shape and arranged in parallel may be also bent.

Further, for example, the tag main body 2 constituting the wide band IC tag 1 may be formed in a predetermined desirable shape such as a triangular shape, a pentagonal shape, a hexagonal shape, a rhombic shape, a star shape, an elliptical shape, a mica shape, etc., and the IC portion 3 may be also arranged near a side portion, an edge portion and an angular corner portion as an end of this tag main body 2.

1. A wide band IC tag for connecting an IC portion arranged in a tag main body and an antenna portion, and functioning in a frequency band from a UHF band to an SHF band;
wherein said IC portion is arranged at an end of said tag main body.

2. The wide band IC tag according to claim 1, wherein the end of said tag main body is constructed by an edge portion or an angular corner portion of the tag main body.

3. The wide band IC tag according to claim 1 or 2, wherein said antenna portion is constructed by an antenna element of a loop shape.

4. The wide band IC tag according to claim 1, wherein said antenna portion is constructed by plural antenna elements of different element lengths.

5. The wide band IC tag according to claim 4, wherein said antenna element is arranged in a comb shape or a fan shape.

6. The wide band IC tag according to claim 3, wherein an arbitrary portion of said antenna element is bent.

7. The wide band IC tag according to claim 3, wherein the number of said antenna elements is set to an arbitrary number.

8. The wide band IC tag according to claim 3, wherein the entire length or one portion of said antenna element is formed in a curve structure.
